(19) United States
(12) Patent Application Publication
(10) Pub. No.: US 2020/0312268 A1
(43) Pub. Date: Oct. 1, 2020

(54) SYSTEMS AND METHODS TO CHANGE SETTING RELATED TO PRESENTATION OF CONTENT BASED ON USER SQUINTING AND/OR USER BLINK RATE

(71) Applicant: Lenovo (Singapore) Pte. Ltd., Singapore (SG)

(72) Inventors: John Weldon Nicholson, Cary, NC (US); Howard Jeffrey Locker, Cary, NC (US); Daryl C. Cromer, Raleigh, NC (US)

(21) Appl. No.: 16/369,945

(22) Filed: Mar. 29, 2019

(51) Int. Cl. G09G 5/00; G06K 9/00; G09G 5/373; G09G 5/10

(52) U.S. Cl. CPC G09G 5/003; G06K 9/00604; G09G 5/373; G09G 5/10; G09G 2354/00; G06F 3/04847; G09G 2320/066; G09G 2320/08; G09G 2320/0626; G09G 2340/0407; G09G 2340/045

(57) ABSTRACT

In one aspect, a device includes at least one processor, a display accessible to the at least one processor, and storage accessible to the at least one processor. The storage includes instructions executable by the at least one processor to present content on the display and to identify at least one condition related to a user's eyes. The instructions are also executable to, based at least in part on the identification, change at least one setting that is being used to present the content on the display and/or present a prompt on the display that includes an instruction for the user to take an action.

### FIELD

The present application relates to technically inventive, non-routine solutions that are necessarily rooted in computer technology and that produce concrete technical improvements.

### BACKGROUND

As recognized herein, users might squint or blink less frequently than normal when looking at content presented on an electronic display. In fact, as also recognized herein, computer vision syndrome (CVS) can often develop due to prolonged viewing of content on an electronic display. CVS can include undesirable side effects such as sore eyes, dry eyes, teary eyes, blurry vision, double vision, light sensitivity, difficulty focusing on images, neck pain, headache, etc. However, many users must deal with these issues as work or personal requirements might nonetheless induce them to look at electronic displays for prolonged periods of time. There are currently no adequate solutions to the foregoing computer-related, technological problem.

### SUMMARY

Accordingly, in one aspect a device includes at least one processor, a display accessible to the at least one processor, and storage accessible to the at least one processor. The storage includes instructions executable by the at least one processor to present content on the display and identify at least one condition related to a user's eyes. The instructions are also executable to, based at least in part on the identification, change at least one setting that is being used to present the content on the display.

In some embodiments, the at least one condition may include a first eye blinking rate that is below a threshold eye blinking rate, e.g., ten blinks per minute. The at least one condition may also include the user squinting.

The instructions may be executable to change the at least one setting that is being used to present the content on the display at least by increasing the size of text presented on the display as part of the content, increasing contrast for the content as presented on the display, increasing brightness of the content as presented on the display, increasing the dots-per-inch scaling factor being used to present the content on the display, and/or lowering the resolution of the display as indicated in a setting accessible to the at least one processor.

In some examples, based at least in part on the identification, the instructions may also be executable to present a prompt on the display, where the prompt includes an instruction for the user to take a predefined action.

Also in some examples, the device may include a camera accessible to the at least one processor, and the instructions may be executable by the at least one processor to receive input from the camera and, based on the input from the camera, identify the at least one condition related to the user's eyes.

In another aspect, a method includes presenting content on an electronic display, receiving input from a camera, and identifying, based on the input from the camera, that a user is squinting and/or blinking at less than a threshold frequency. The method also includes, based at least in part on the identifying, changing at least one setting that is being used to present the content on the electronic display and/or presenting a prompt on the electronic display that includes an instruction for the user to take an action.

In still another aspect, a computer readable storage medium (CRSM) that is not a transitory signal includes instructions executable by at least one processor to present content on a display accessible to the at least one processor and to identify that a user is squinting and/or blinking at less than a threshold frequency. The instructions are also executable to, based at least in part on the identification, change at least one setting that is being used to present the content on the display and/or present a graphical user interface (GUI) on the display that indicates an action for the user to take.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIGS. 3 and 4 show graphical user interfaces (GUIs) with content presented respectively before and after one or more display settings adjustments in accordance with present principles;

FIG. 5 is a flow chart of an example algorithm in accordance with present principles; and

FIGS. 6 and 7 show example GUIs that may be presented based on detection of a user as squinting or blinking at less than a threshold rate in accordance with present principles; and

FIG. 8 shows an example settings GUI at which one or more settings for a device undertaking present principles may be configured.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones, mixed reality devices, virtual reality devices, and augmented reality devices. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices.

Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSL and includes programmable logic components programmed to perform the functions of an embodiment as well as general-purpose or special-purpose processors programmed with instructions to perform those functions.

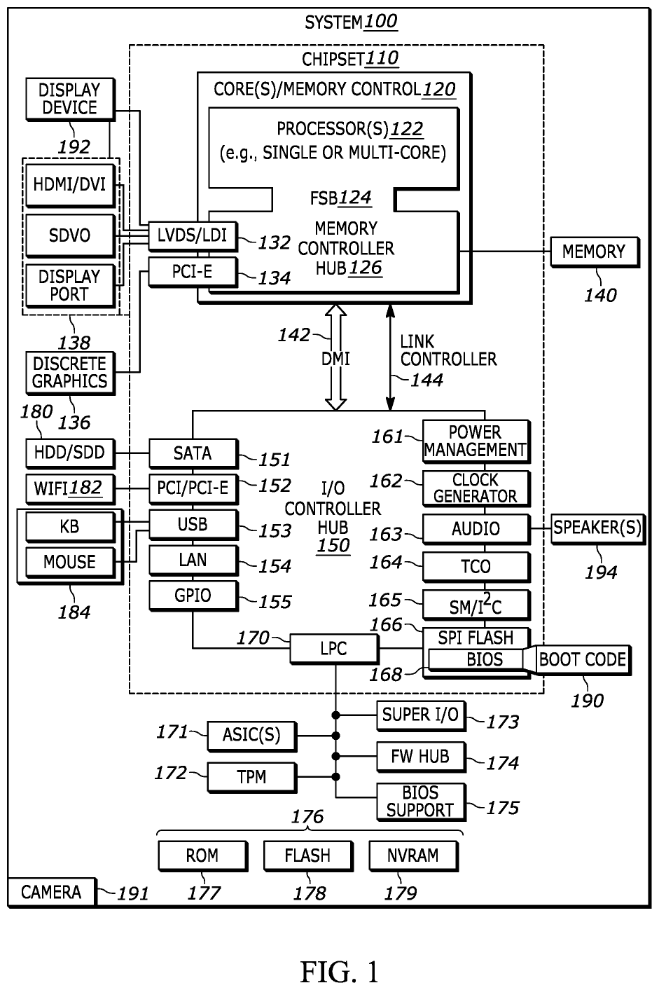

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Still further, the system 100 may also include a camera 191 that gathers one or more images and provides input related thereto to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

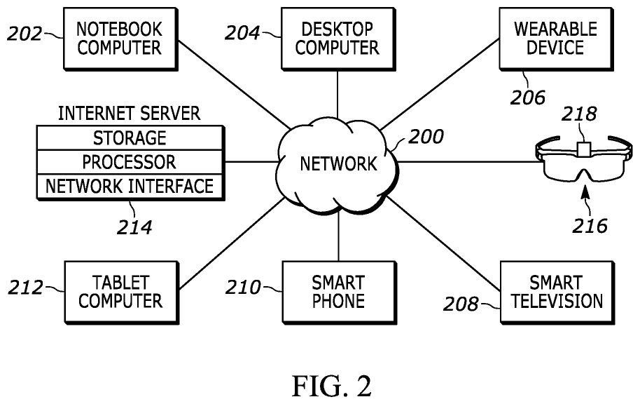

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216, and a server 214 such as an Internet server that may provide cloud storage accessible to the devices 202-212, 216. It is to be understood that the devices 202-216 are configured to communicate with each other over the network 200 to undertake present principles.

Describing the headset 216 in more detail, it may be a virtual reality (VR) headset in some examples, an augmented reality (AR) headset in other examples, Internet-enabled computerized glasses in still other examples, etc. The headset 216 may include, among other things, one or more cameras 218 that may each be similar in function and configuration to the camera 191 described above, with at least one of the cameras 218 oriented to image a wearer's eyes when wearing the headset 216 for eye tracking as described herein. Though not shown for clarity, it is to be understood that the headset 216 may also include a network interface for wired and/or wireless communication with other devices in accordance with present principles via the Internet, a local area network (LAN), a Bluetooth network, etc.

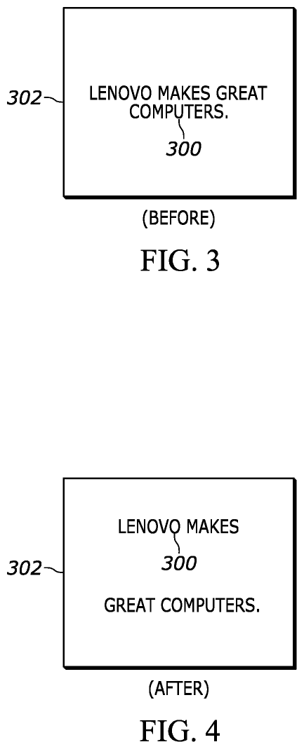

Referring to FIG. 3, it shows example content 300 presented on an electronic display 302 to illustrate present principles. As may be appreciated from FIG. 3, the content 300 includes text that indicates the following: “Lenovo makes great computers.” It is to be understood that, as shown in FIG. 3, the content 300 is being presented per one or more default settings for presenting content and its presentation has not yet been altered based on a user squinting and/or blinking at less than a threshold frequency in accordance with present principles.

However, once the device controlling the display 302 determines based on camera input and execution of eye tracking software that a user that is viewing the display is squinting and/or blinking at less than the threshold frequency, the content 300 may be enlarged and reformatted as shown in FIG. 4. As shown in this figure, the font size for the text “Lenovo makes great computers” has been increased and, owing to this increase, the last two words of the text have been moved down into a second line of text as opposed to the single line of text shown in FIG. 3. The device itself that is controlling the display 302 may be, e.g., a smartphone, a laptop computer, a desktop computer, etc. However, note that the device may also be a headset such as a mixed reality headset, a virtual reality headset, or an augmented reality headset, with the content 300 presented on the headset's display. Thus, it is to be understood that the principles described herein may also be applied to content (e.g., virtual content) presented on such head-mounted devices so that adjustments to settings for content presentation may be made if a user is squinting or blinking less that the threshold frequency while viewing content presented via the headset's display.

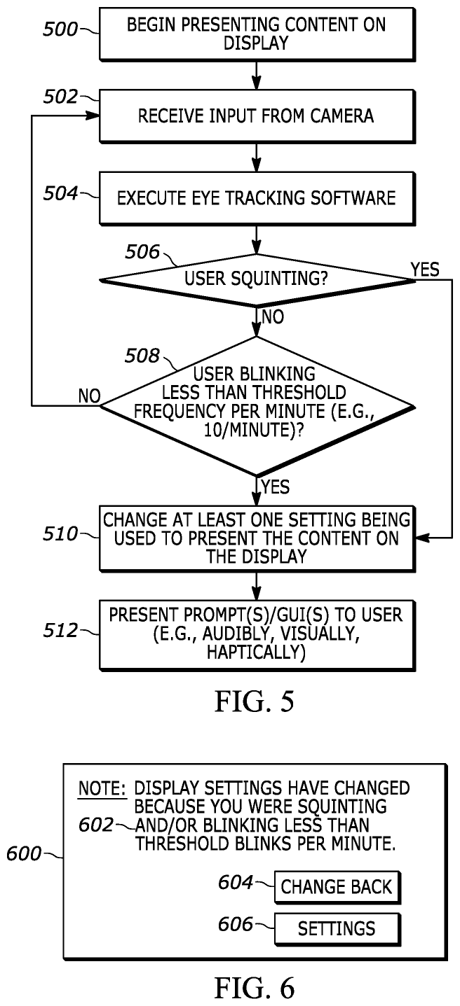

FIG. 5 shows example logic that may be executed by a device such as the system 100 in accordance with present principles. Beginning at block 500, the device may begin to present content on a display. The content may be, for example, a web page, a word processing document, a video or still image, a graphical user interface (GUI), etc.

The logic may then move to block 502 where the device may activate a camera with which it communicates and then receive input (e.g., images) therefrom. The camera may be an infrared (IR) camera, and it may be mechanically coupled to the device or in wired or wireless communication with it (such as if the camera were located on the headset 216 described above). Thereafter, the device may execute eye tracking software at block 504 using the input from the camera (e.g., IR images) to determine at diamond 506 whether a user identified from the input is squinting.

Squinting may be identified based on image analysis and subsequent identification of an amount of exposed area of the eye, e.g., areas of the eye not covered by the user's eye lids. If the amount of exposed eye area is less than a threshold area, squinting may be determined. However, if the amount of exposed eye area is more than the threshold area, it may be determined that the user is not squinting. The threshold area itself may be established by the device manufacturer or may be learned, e.g., based on the user's average exposed eye area while looking at the display for the first five minutes each time the user begins looking at the display during a new sign-on session to the computer/device. Crowdsourced data for a set of different users may also be used to learn an average exposed eye area and establish the threshold area as the average exposed eye area.

Furthermore, in some examples the threshold area and currently-exposed area identified from the camera input received at block 502 may both be expressed proportional to total eye area, inclusive of areas covered by eye lids, so that regardless of the distance between the camera and the user (and hence the size of the user's eyes as appearing in the images), the device may determine whether the user is squinting by identifying total eye area and exposed eye area at any given distance. In other examples, the device may determine the distance to the user (e.g., using a laser rangefinder or using the camera itself) and determine absolute total and exposed eye areas after accounting for the distance and hence size of the eye as shown in a given image taken from the determined distance.

In addition to or in lieu of the foregoing, squinting may also be identified based on execution of eye tracking software and/or object recognition software to identify of the shape of the user's eyes. If the shape of one or both of the user's eyes is less circular than a threshold shape, squinting may be determined. However, if the shape of one or both eyes is more circular than the threshold shape, then it may be determined that the user is not squinting.

Still further, pupil dilation for one or both eyes may be identified to determine whether the user is squinting. For example, pupil area as established by the identified circumference of the pupil (e.g., identified via input from the camera) may be compared to a threshold pupil area. If the identified current pupil area for one or both of the user's eyes is more than the threshold pupil area, squinting may be determined by the device. Conversely, if the identified current pupil area is less than the threshold pupil area, the device may determine that the user is not squinting.

The threshold pupil area itself may be established by the device manufacturer or may be learned, e.g., based on the user's average pupil area while looking at the display for the first five minutes each time the user begins looking at the display during a new sign-on session to the computer/device. Crowdsourced data for a set of different users may also be used to learn an average pupil area and establish the threshold pupil area as the average pupil area. Furthermore, the threshold pupil area and current pupil area identified from the camera input received at block 502 may both be expressed proportional to total eye area (or total iris area) similar to what is set forth above with respect to exposed eye area, or they may be expressed in absolute terms also similar to what is set forth above with respect to exposed eye area.

Still in reference to diamond 506, an affirmative determination at this step may cause the logic to proceed to block 510, which will be described shortly. However, first note that a negative determination at diamond 506 may instead cause the logic to move to decision diamond 508. At diamond 508 the device may determine, based on the input from the camera received at block 502 and execution of eye tracking software, whether the user is blinking his or her eyes at less than a threshold blinking rate/frequency. The threshold frequency for blinking may be a number of blinks per minute or per another time increment, but in either case it is to be generally understood that less blinking may correlate to a user squinting and/or the user otherwise straining to view the content presented on the display due to computer vision syndrome (CVS). Less blinking may also be a precursor to CVS.

The blinking itself may be identified by the device based on identification, using eye tracking software, of the user's eye lids as completely obstructing all portions of the user's eye(s) from being shown in one or more camera images. The obstructing may be, e.g. for any length of time or for a threshold length of time such as one second. Additionally or alternatively, the device may simply determine that the user's eyes cannot be identified from one or more images that show the user's face and hence that the user has blinked.

Regarding the threshold frequency, in some examples it may be ten blinks per minute. This may be because, in normal conditions without squinting or experiencing symptoms of CVS, a user may blink between fifteen and eighteen times per minute on average. However, once squinting or symptoms of CVS set in, or simply by staring at a display for a prolonged period of time (eventually causing CVS symptoms), a user's blink rate might be reduced to seven or eight times per minute on average. Thus, a threshold frequency of ten blinks per minute may be used to offset some conditions of CVS or the need to squint during a given viewing session, before they fully set in.

A negative determination at diamond 508 may cause the logic to revert back to block 502 to proceed therefrom. However, an affirmative determination at diamond 508 may cause the logic to proceed to block 510. At block 510, the device may change one or more settings that are being used to present content on the display. For example, the font size in which text is being presented as part of the content may be increased by the device, e.g., to eliminate some of the need to squint. Additionally or alternatively, the device may increase the black/white and/or color contrast in which the content is presented, e.g., again to eliminate the need to squint. Still further, display brightness may be increased by the device, e.g., to eliminate apparent glare that might cause squinting.

As yet another example, the device may increase the dots-per-inch (DPI) scaling factor that might be used by the device's operating system and/or a particular application being used to present the content, which may result in text, buttons, graphical objects, etc. appearing larger on the display. As but one more example, the device may lower the reported display screen resolution so that the device's operating system and/or a particular application being used to present the content provides content formatted for a lower resolution display (e.g., a display with relatively less pixels), which the actual display will then scale back up when presenting the content to thus make the content appear larger on the display.

At block 510 the device may adjust one or more of the foregoing settings automatically responsive to affirmative determinations at either of diamonds 506 or 508.

However, in some embodiments the device may first (or after changing the settings) provide a prompt or other graphical user interface (GUI) to the user responsive to affirmative determinations at either of diamonds 506 or 508 to indicate that one or more display settings will be or have been changed. This may occur at block 512. The prompt (or other GUI) may be presented on the display, but such a prompt may also be presented audibly or haptically to the user as well.

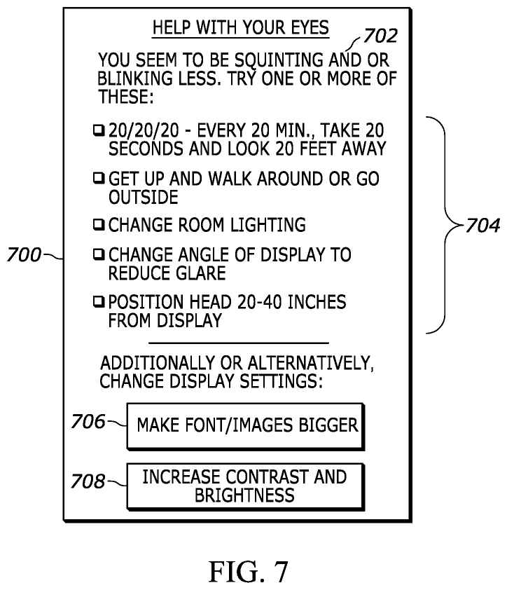

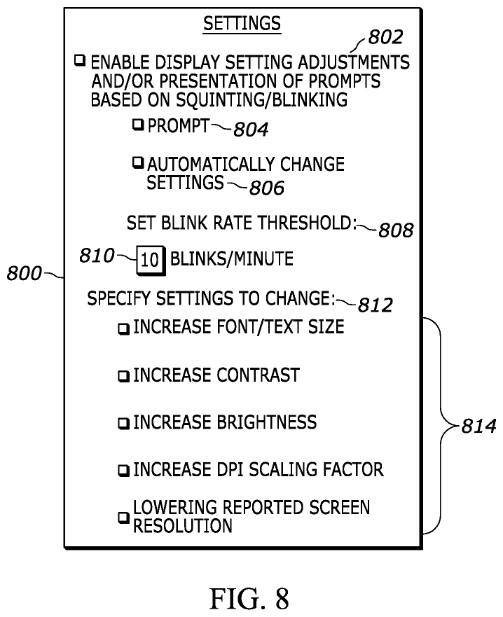

An example of such a prompt/GUI as presented on a display at block 512 is shown in FIG. 6. As shown, a GUI 600 may include a notification 602 that one or more settings for a display have changed because the user was squinting and/or blinking less than a threshold number of blinks per minute. The GUI 600 may also include a selector 604 that is selectable by the user to provide a command to the device to change the one or more settings back to their previous configuration prior to being changed because of the user's squinting and/or reduced blinking. A selector 606 may also be presented, with the selector 606 being selectable to present a GUI for configuring display settings, such as the GUI 800 of FIG. 8 that will be described at a later point below.

A prompt or GUI as presented at block 512 of FIG. 5 may also provide suggestions to the user for the user to take one or more actions to reduce squinting or onset of CVS. For example, the pop-up GUI 700 of FIG. 7 may also be presented on a display accessible to the device at block 512. The GUI 700 may include an indication 702 that the device has detected that the user is squinting and/or has reduced his or her blinking below the threshold frequency. The GUI 700 may then list several suggestions 704.

For example, one suggestion shown on the GUI 700 is to abide by the so-called “20-20-20” rule, whereby a user takes twenty seconds to look twenty feet away every twenty minutes to help reduce onset of CVS symptoms and/or squinting. Another suggestion may be for the user to stop interacting with the device and to walk around or go outside. Still other suggestions may include changing the lighting in the room in which the user is located, changing the angle of the display with respect to the user to help reduce glare, and for the user to position himself or herself between twenty and forty inches from the display as this distance range may also help reduce squinting and/or onset of CVS symptoms.

Specifically regarding this suggestion for the user to position himself or herself between twenty and forty inches from the display, this suggestion might be provided if, for example, the device receives an image from the camera and executes a distance determination algorithm to determine that the user's face (or eyes, in particular) is currently not within the range of twenty and forty inches from the display. This determination might be based on identification of the user's face as respectively appearing larger or smaller than it should at twenty to forty inches from the display according to the field of view of the camera as represented in the image.

Still in reference to FIG. 7, in some embodiments the GUI 700 may include one or more selectors that are respectively selectable to provide respective commands to the device to change one display setting or another to help reduce squinting and/or onset of CVS. For example, a selector 706 may be presented that is selectable to change a content size setting for the device to increase the size of text and images so that they appear bigger to the user. A selector 708 may also be presented, with the selector 708 being selectable to command the device to change display settings for the device by increasing both display contrast and display brightness. However, note that other selectors that might be included on this portion of the GUI 700 may include selectors for commanding the device to adjust any other display setting disclosed herein.

Briefly referring back to FIG. 5 again, it is to be understood in reference to block 510 that, in some examples, after execution of block 510 a first time during any given viewing or login session, the device may revert back to block 502 from block 510 after automatically adjusting one or more settings a first time. The device may wait a threshold amount of time (e.g., ten minutes) and then determine whether the user is still squinting or blinking less than the threshold frequency at diamonds 506 and 508, respectively, before arriving at block 510 again to make further settings adjustments. In this example, upon reaching block 510 a second time for a given viewing/login session, the device may again automatically adjust one or more settings and/or the device may simply proceed to block 512 and present a GUI such as the GUI 700 so that a user may take action himself or herself according to the suggestions indicated on the GUI 700 to further help reduce squinting or to increase blink rate.

Now in reference to FIG. 8, it shows a GUI 800 for configuring one or more settings of a device undertaking present principles. The GUI 800 may be presented based on selection of the selector 606, or by navigation to an appropriate settings menu for the device. In any case, it is to be understood that each of the options or sub-options disclosed below may be selected by selecting the corresponding check box shown adjacent to each option or sub-option.

As shown, the GUI 800 of FIG. 8 may include a first option 802 that is selectable to configure the device perform display setting adjustments as disclosed herein, and/or to present prompts and other GUIs as disclosed herein, based on identifications of a user as squinting or blinking at less than a threshold frequency. Thus, for example, selection of the option 802 may configure the device to present content and take actions according to the logic of FIG. 5. The option 802 may also be accompanied by sub-options 804 and 806, with sub-option 804 being selectable to configure the device to prompt a user before changing any display setting based on identifications of squinting or blinking at a rate less than the threshold frequency. Sub-option 806 may be selectable to configure the device to automatically change the display settings without first requesting user input or confirmation.

The GUI 800 may also include a section 808 at which the user may establish the threshold blink rate frequency. This may be done via input box 810, where a user may enter a number of blinks per minute for the device to use as the threshold.

The GUI 800 may also include a section 812 listing various options 814. Each option 814 may be selectable to set the device to change a respective display setting associated with the respective option. Examples as shown in FIG. 8 include increasing font/text size, increasing display contrast, increasing display brightness, increasing the DPI scaling factor, and lowering the reported screen resolution.

Moving on from the description of FIG. 8 and in reference to changing the angle of the display with respect to the user to help reduce glare, in addition to the device instructing the user to do so, in some embodiments the device itself may be able to control movement of the display via one or more computer-controllable motors to rotate the display along one or more axes. The device may do so responsive to detecting squinting or blinking less than a threshold frequency, and may do so incrementally while continuing to determine whether the user might be squinting less or blinking more.

Also, note that in some embodiments, in addition to or in lieu of adjusting one or more display settings responsive to detecting squinting or blinking at less than a threshold frequency, the device may determine, based on execution of eye tracking software using images from a camera, an area of the display at which the user is looking. The device may then automatically zoom in on that area so that the user may more easily view the portion of content at which he or she is looking.

It may now be appreciated that present principles provide for an improved computer-based user interface that improves the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor;
a display accessible to the at least one processor; and
storage accessible to the at least one processor and comprising instructions executable by the at least one processor to:
present content on the display;
identify at least one condition related to a user's eyes; and
based at least in part on the identification, change at least one setting that is being used to present the content on the display.

2. The device of claim 1, wherein the at least one condition comprises a first eye blinking rate that is below a threshold eye blinking rate.

3. The device of claim 2, wherein the threshold eye blinking rate is ten blinks per minute.

4. The device of claim 1, wherein the at least one condition comprises the user squinting.

5. The device of claim 1, wherein the instructions are executable by the at least one processor to:
change at least one setting that is being used to present the content on the display at least by increasing the size of text presented on the display as part of the content.

6. The device of claim 1, wherein the instructions are executable by the at least one processor to:
change at least one setting that is being used to present the content on the display at least by increasing contrast for the content as presented on the display.

7. The device of claim 1, wherein the instructions are executable by the at least one processor to:
change at least one setting that is being used to present the content on the display at least by increasing brightness of the content as presented on the display.

8. The device of claim 1, wherein the instructions are executable by the at least one processor to:
change at least one setting that is being used to present the content on the display at least by increasing the dots-per-inch scaling factor being used to present the content on the display.

9. The device of claim 1, wherein the instructions are executable by the at least one processor to:
change at least one setting that is being used to present the content on the display at least by lowering the resolution of the display as indicated in a setting accessible to the at least one processor.

10. The device of claim 1, wherein the instructions are executable by the at least one processor to:
based at least in part on the identification, present a prompt on the display, the prompt comprising an instruction for the user to take a predefined action.

11. The device of claim 1, comprising a camera accessible to the at least one processor, and wherein the instructions are executable by the at least one processor to:
receive input from the camera; and
based on the input from the camera, identify at least one condition related to the user's eyes.

12. A method, comprising:
presenting content on an electronic display;
receiving input from a camera;
identifying, based on the input from the camera, that a user is squinting and/or blinking at less than a threshold frequency; and
based at least in part on the identifying: changing at least one setting that is being used to present the content on the electronic display and/or presenting a prompt on the electronic display, the prompt comprising an instruction for the user to take an action.

13. The method of claim 12, comprising:
identifying, based on the input from the camera, that the user is squinting.

14. The method of claim 12, comprising:
identifying, based on the input from the camera, that the user is blinking at less than the threshold frequency.

15. The method of claim 12, comprising:
based at least in part on the identifying, changing the at least one setting that is being used to present the content on the electronic display.

16. The method of claim 15, wherein changing the at least one setting comprises:
increasing the size of text presented on the electronic display as part of the content, increasing contrast for the content as presented on the electronic display, increasing brightness of the content as presented on the electronic display, increasing the dots-per-inch scaling factor being used to present the content on the electronic display, and/or lowering the resolution of the electronic display as indicated in a setting.

17. The method of claim 12, comprising:
based at least in part on the identifying, presenting the prompt on the electronic display.

18. A computer readable storage medium (CRSM) that is not a transitory signal, the computer readable storage medium comprising instructions executable by at least one processor to:
present content on a display accessible to the at least one processor;
identify that a user is squinting and/or blinking at less than a threshold frequency; and
based at least in part on the identification, change at least one setting that is being used to present the content on the display and/or present a graphical user interface (GUI) on the display that indicates an action for the user to take.

19. The CRSM of claim 18, wherein the instructions are executable by the at least one processor to:
based at least in part on the identification, change the at least one setting that is being used to present the content on the display.

20. The CRSM of claim 18, wherein the instructions are executable by the at least one processor to:
based at least in part on the identification, present the GUI on the display, wherein the GUI comprises a selector that is selectable to provide a command for the at least one processor to change at least one setting that is being used to present the content on the display.
